(19) United States
(12) Patent Application Publication
(10) Pub. No.: US 2019/0179749 A1
(43) Pub. Date: Jun. 13, 2019

(54) MEMORY SYSTEM, OPERATING METHOD THEREOF AND NONVOLATILE MEMORY DEVICE

(71) Applicant: SK hynix Inc., Gyeonggi-do (KR)

(72) Inventor: Joo Young LEE, Seoul (KR)

(21) Appl. No.: 16/028,631

(22) Filed: Jul. 6, 2018

(30) Foreign Application Priority Data
Dec. 12, 2017 (KR) 10-2017-0170366

(51) Int. Cl. G06F 12/0802; G06F 3/06

(52) U.S. Cl. CPC G06F 12/0802; G06F 3/0619; G06F 3/0656; G06F 2212/1032; G06F 3/0659; G06F 3/0679; G06F 3/0658

(57) ABSTRACT

A nonvolatile memory device includes a page buffer configured to, store first data and program the first data to a first page, based on a program command for first data transmitted from a controller; a temporary buffer configured to receive and store the first data from the page buffer; a controller interface configured to perform interface with the controller; and a program control circuit configured to control operations of the page buffer and the temporary buffer, wherein the program control circuit controls the temporary buffer to receive and store the first data from the page buffer when a program fail has occurred.

### CROSS-REFERENCES TO RELATED APPLICATION

The present application claims priority under 35 U.S.C. § 119(a) to Korean application number 10-2017-0170366, filed on Dec. 12, 2017, in the Korean Intellectual Property Office, which is incorporated herein by reference in its entirety.

### BACKGROUND

### 1. Technical Field

Various exemplary embodiments of the present disclosure generally relate to a memory system. Particularly, the embodiments relate to a memory system including a nonvolatile memory device.

### 2. Related Art

A memory system may store the data provided from an external device, in response to a write or program request from the external device. Also, the memory system may provide stored data to the external device, in response to a read request from the external device. The external device may be an electronic device capable of processing data such as a computer, a digital camera, or a mobile phone. The memory system may be built in the external device, or may be manufactured in a separable form and be coupled to the external device.

Since a memory system using a memory device has no mechanical driving part, some of the advantages include excellent stability and durability, high information access speed, and low power consumption. Memory systems having such advantages include a universal serial bus (USB) memory device, memory cards having various interfaces, a universal flash storage (UFS) device, and a solid state drive (SSD).

### SUMMARY

Various embodiments are directed to a memory system in which data may be stored in a temporary buffer when a program fail occurs and thus other commands may be performed regardless of recovery of the data.

In an embodiment, a nonvolatile memory device may include: a page buffer configured to store first data and program the first data to a first page, based on a program command for first data transmitted from a controller; a temporary buffer configured to receive and store the first data from the page buffer; a controller interface configured to perform interface with the controller; and a program control circuit configured to control operations of the page buffer and the temporary buffer, wherein the program control circuit controls the temporary buffer to receive and store the first data from the page buffer when a program fail has occurred.

In an embodiment, a memory system may include: a controller; and a nonvolatile memory device configured to include a page buffer, a temporary buffer which receives and stores first data from the page buffer when a program fail has occurred in a process of programming first data stored in the page buffer, a controller interface which performs interface with the controller and a program control circuit which controls operations of the page buffer and the temporary buffer, wherein the controller transmits a reprogram command for the first data to the nonvolatile memory device, and wherein the program control circuit controls the first data stored in the temporary buffer to be reprogrammed to a fourth page, based on the reprogram command.

In an embodiment, a method for operating a memory system may include: programming first data stored in a page buffer, to a first page by a nonvolatile memory device; and receiving and storing the first data from the page buffer by a temporary buffer when a program fail has occurred.

In the memory system according to the embodiment, data may be stored in a temporary buffer when a program fail occurs and thus other commands may be performed regardless of recovery of the data. Therefore, since interface including data is minimized in the process of recovering data, a processing speed may be improved.

In an embodiment, memory system may include: a memory device including a memory cell array and first and second buffers; and a controller suitable for: controlling the memory device to perform a program operation of storing data into the memory cell array by temporarily buffering the data into the first buffer; controlling, when the program operation fails, the memory device to buffer the data into the second buffer during another operation with the first buffer; and controlling the memory device to perform a re-program operation of storing the data, which is buffered in the second buffer, into the memory cell array.

### BRIEF DESCRIPTION OF THE DRAWINGS

FIG. 1 is a block diagram illustrating a memory system in accordance with an embodiment of the present disclosure.

FIG. 2 is a diagram describing a process in which data is stored in a temporary buffer, in accordance with an embodiment.

FIG. 3 is a diagram describing a process in which a program operation for another data is performed after data is stored in a temporary buffer, in accordance with an embodiment.

FIG. 4 is a diagram describing a process in which a read operation for another data is performed after data is stored in a temporary buffer, in accordance with an embodiment.

FIG. 5 is a diagram describing a process in which data is reprogrammed, in accordance with an embodiment.

FIG. 6 is a diagram describing a process in which data is reprogrammed, in accordance with an embodiment.

FIG. 7 is a flow chart describing a method for operating a memory system in accordance with an embodiment.

FIG. 8 is a flow chart describing a method for operating a memory system in accordance with an embodiment.

FIG. 9 is a flow chart describing a method for operating a memory system in accordance with an embodiment.

FIG. 10 is a diagram illustrating an example of a data processing system including a solid state drive (SSD) in accordance with an embodiment.

FIG. 11 is a diagram illustrating an example of a data processing system including a memory system in accordance with an embodiment.

FIG. 12 is a diagram illustrating an example of a data processing system including a memory system in accordance with an embodiment.

FIG. 13 is a diagram illustrating an example of a network system including a memory system in accordance with an embodiment.

FIG. 14 is a block diagram illustrating an example of a nonvolatile memory device included in a memory system in accordance with an embodiment.

### DETAILED DESCRIPTION

The advantages, features, and methods of the present invention will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a memory system, an operating method thereof and a nonvolatile memory device will be described below with reference to the accompanying drawings through various examples of embodiments.

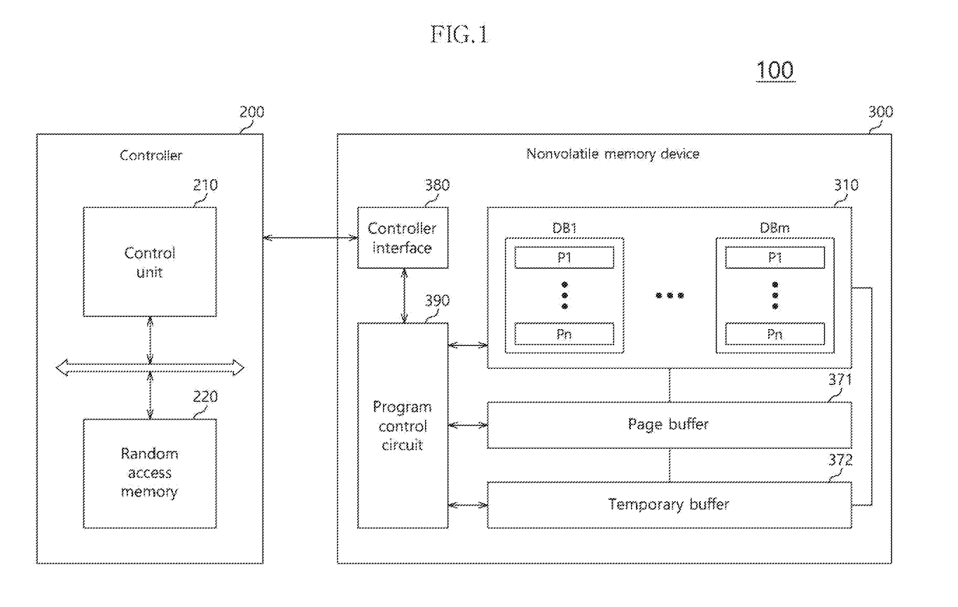

FIG. 1 is a block diagram illustrating an example of a memory system 100 in accordance with an embodiment of the present disclosure.

The memory system 100 may store data to be accessed by a host device (not shown) such as a mobile phone, an MP3 player, a laptop computer, a desktop computer, a game player, a TV, an in-vehicle infotainment system, and so forth. The memory system 100 may be referred to as a memory module or a memory card.

The memory system 100 may be manufactured as any one of various kinds of storage devices according to a host interface meaning a transmission protocol with respect to the host device. For example, the memory system 100 may be configured as any one of various kinds of storage devices such as a solid state drive (SSD), a multimedia card in the form of an MMC, an eMMC, an RS-MMC and a micro-MMC, a secure digital card in the form of an SD, a mini-SD and a micro-SD, a universal serial bus (USB) storage device, a universal flash storage (UFS) device, a Personal Computer Memory Card International Association (PCMCIA) card type storage device, a peripheral component interconnection (PCI) card type storage device, a PCI express (PCI-E) card type storage device, a compact flash (CF) card, a smart media card, a memory stick, and so forth.

The memory system 100 may be manufactured as any one among various kinds of package types. For example, the memory system 100 may be manufactured as any one of various kinds of package types such as a package-on-package (POP), a system-in-package (SIP), a system-on-chip (SOC), a multi-chip package (MCP), a chip-on-board (COB), a wafer-level fabricated package (WFP), and a wafer-level stack package (WSP).

Referring to FIG. 1, the memory system 100 in accordance with the embodiment may include a controller 200. The controller 200 may include a control unit 210, a random access memory 220, a host interface unit (not shown), and a memory control unit (not shown).

The control unit 210 may be configured by a micro control unit (MCU) or a central processing unit (CPU). The control unit 210 may process a request transmitted from the host device. In order to process the request, the control unit 210 may drive an instruction or algorithm of a code type, that is, a firmware (FW), loaded in the random access memory 220, and may control internal function blocks and a nonvolatile memory device 300.

The random access memory 220 may be configured by a random access memory such as a dynamic random access memory (DRAM) or a static random access memory (SRAM). The random access memory 220 may store the firmware (FW) to be driven by the control unit 210. Also, the random access memory 220 may store data necessary for driving the firmware (FW), for example, metadata. That is, the random access memory 220 may operate as the working memory of the control unit 210.

The host interface unit may interface the host device and the memory system 100. For example, the host interface unit may communicate with the host device by using a host interface (HIF), that is, any one among standard transmission protocols such as universal serial bus (USB), universal flash storage (UFS), multimedia card (MMC), parallel advanced technology attachment (DATA), serial advanced technology attachment (SATA), small computer system interface (SCSI), serial attached SCSI (SAS), peripheral component interconnection (PCI), and PCI express (PCI-E) protocols.

The memory control unit may control the nonvolatile memory device 300 according to the control of the control unit 210. The memory control unit may also be referred to as a memory interface unit. The memory control unit may provide control signals to the nonvolatile memory device 300. The control signals may include a command, an address, a control signal, and so forth for controlling the nonvolatile memory device 300. The memory control unit may provide data to the nonvolatile memory device 300 or may be provided with data from the nonvolatile memory device 300.

The memory system 100 in accordance with the embodiment may include the nonvolatile memory device 300. The nonvolatile memory device 300 may be coupled with the controller 200 through a channel which includes at least one signal line capable of transmitting a command, an address, control signals, and data. The nonvolatile memory device 300 may be used as the storage medium of the memory system 100.

The nonvolatile memory device 300 may be configured by any one of various types of nonvolatile memory devices such as a NAND flash memory device, a NOR flash memory device, a ferroelectric random access memory (FRAM) using a ferroelectric capacitor, a magnetic random access memory (MRAM) using a tunneling magneto-resistive (TMR) layer, a phase change random access memory (PCRAM) using a chalcogenide alloy, and a resistive random access memory (RERAM) using a transition metal oxide.

The nonvolatile memory device 300 may include a memory cell array 310. The memory cells included in the memory cell array 310 may be configured as a hierarchical memory cell set or memory cell unit from an operational viewpoint or a physical (or structural) viewpoint. For example, memory cells which are coupled to the same word line and are to be read and written (or programmed) simultaneously may be configured as a page. In the following descriptions, for the sake of convenience in explanation, memory cells configured as a page will be referred to as a “page.” Also, memory cells to be erased simultaneously may be configured as a memory block. The memory cell array 310 may include a plurality of memory blocks DB1 to DBm, and each of the memory blocks DB1 to DBm may include a plurality of pages P1 to Pn.

Each of the memory blocks DB1 to DBm may be used as a buffer block or a data block by the control unit 210. The buffer block may be defined as a memory block which is used temporarily before data according to a write request or a program request of the host device is written in the data block. The buffer block may be referred to as a “log block” or an “open block”. The data block may be defined as a memory block in which data written in the buffer block is finally written.

As illustrated in FIG. 1, the nonvolatile memory device 300 in accordance with the embodiment may include a page buffer 371 which stores first data and programs the first data to a first page P1, based on a program command for the first data transmitted from the controller 200; a temporary buffer 372 which receives the first data from the page buffer 371 and stores the first data therein when a program of the first data fails; a controller interface 380 which performs interface with the controller 200; and a program control circuit 390 which controls the operations of the page buffer 371 and the temporary buffer 372.

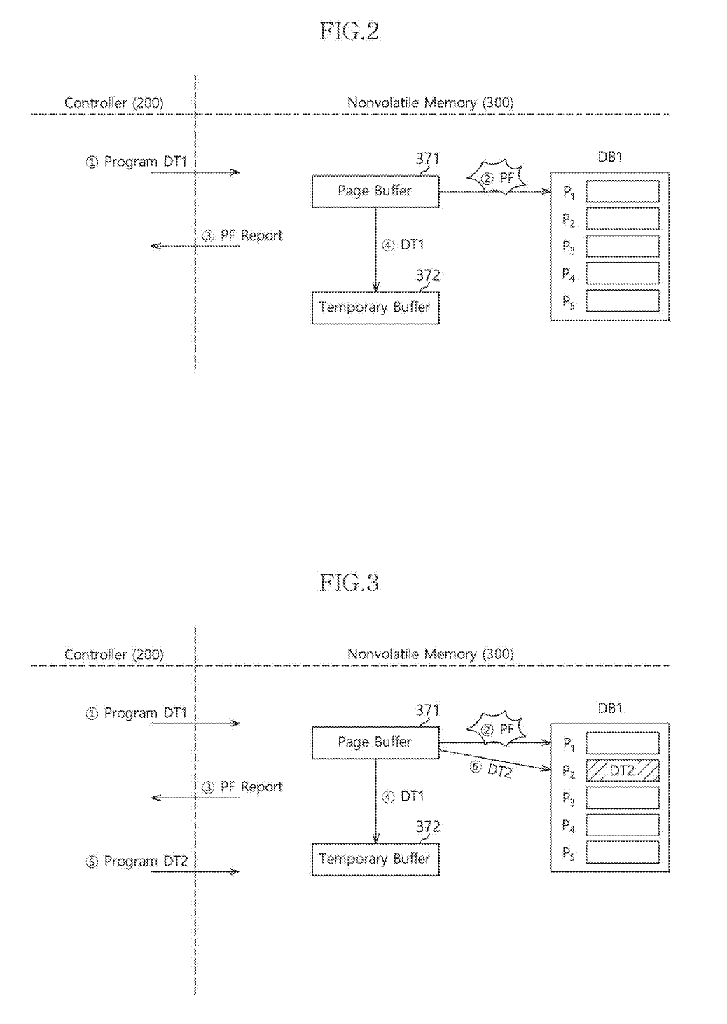

FIG. 2 is a diagram describing a process in which data is stored in the temporary buffer 372 in accordance with an embodiment. For convenience of explanation and illustrative purposes, a first memory block DB1 including five pages P1 to P5 is illustrated in FIG. 2, as an example. Hereunder, the embodiment will be described with reference to FIGS. 1 and 2.

At step \textcircled{1}, the controller 200 transmits a program command for first data DT1 to the nonvolatile memory device 300. The program command may include the first data DT1 and an information on an address corresponding to a first page P1 in which the first data DT1 is to be stored.

At step \textcircled{2}, the program control circuit 390 may control a program operation for the first data DT1 based on the program command of the controller 200. In detail, the program control circuit 390 may control the first data DT1 received from the controller 200, to be stored in the page buffer 371, and may control the first data DT1 stored in the page buffer 371, to be programmed to the first page P1. As shown, it is assumed that a program fail (denoted as “PF” in FIG. 2) has occurred in a process of programming the first data DT1 to the first page P1.

At step \textcircled{3}, the controller interface 380 may transmit a program result for the first data DT1, including a program fail occurrence information (denoted as “PF Report” in FIG. 2), to the controller 200.

At step \textcircled{4}, the program control circuit 390 may control the first data DT1 stored in the page buffer 371, to be transmitted to the temporary buffer 372, and may control the temporary buffer 372 to store the first data DT1.

While the temporary buffer 372 in accordance with the embodiment may be set to store the data stored in the page buffer 371 when a program fail occurs, it is to be noted that the present embodiment is not limited thereto. That is, the temporary buffer 372 may also operate as a general page buffer 371. When a program fail does not occur, the temporary buffer 372 may perform operations of storing data to be programmed and transmitting the data to a page to be programmed, in correspondence to a program command of the controller 200, and may store the data read from a page where the data is stored, in correspondence to a read command of the controller 200.

The host interface unit (not shown) may insert or enqueue a host request generated based on a request transmitted from the host device, in a request queue. When a plurality of host requests are enqueued in the request queue, commands corresponding to the host requests are transmitted to the controller interface 380 based on a sequence in which the host requests are received.

According to prior art, however, when a program fail occurs in a process in which data is programmed to a page of the nonvolatile memory device 300, in order to prevent the loss of the data, a reprogram command for the data in which the program fail has occurred is preferentially transmitted from the controller 200 to the controller interface 380, and the host requests enqueued in the request queue are backed up and dequeued. A process in which the data stored in the page buffer 371 is read and stored in the controller 200 and the backed-up host requests are enqueued again in the request queue is performed. In this case, the processing speeds of the host requests may be slowed as the host requests are backed up and dequeued, a data recovery command is transmitted and the host requests are rearranged (enqueued). In particular, in a process in which the controller 200 receives the data stored in the page buffer 371 and transmits again the data to the nonvolatile memory device 300 in response to a reprogram command, a processing speed may be slowed, and as a result, the performance of the memory system 100 may be degraded.

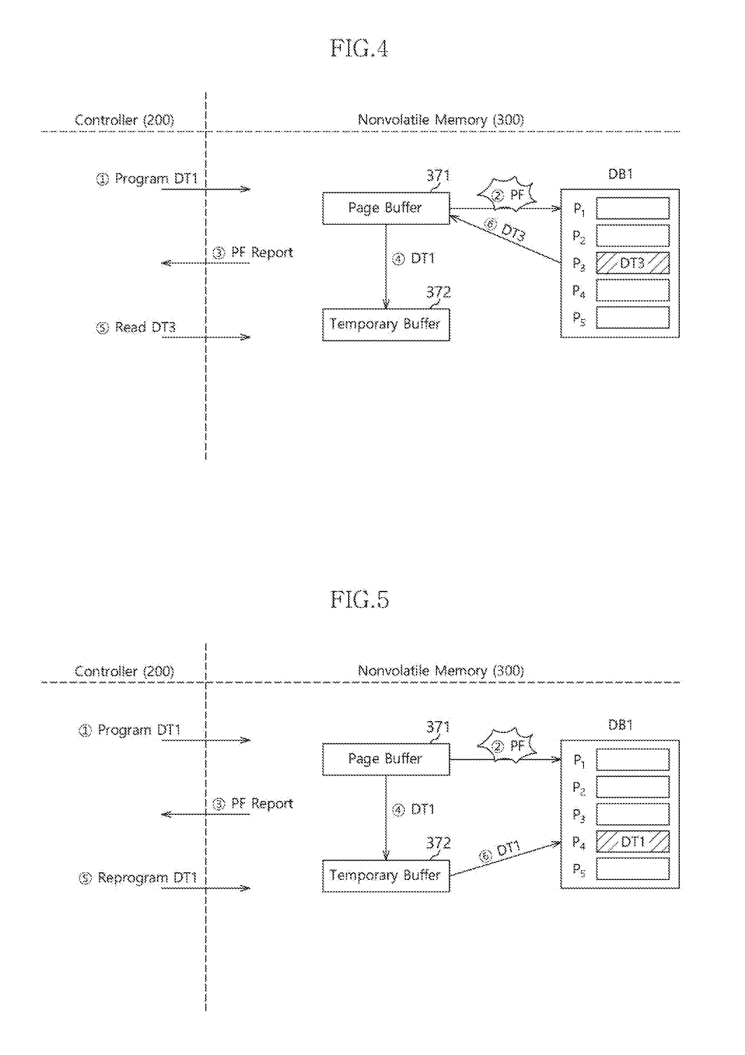

FIG. 3 is a diagram describing a process in which a program operation for another data is performed after data is stored in the temporary buffer 372 in accordance with an embodiment. For convenience of explanation and illustrative purposes, a first memory block DB1 including five pages P1 to P5 is illustrated in FIG. 3, as an example. Hereunder, the embodiment will be described with reference to FIGS. 1 to 3.

For step \textcircled{1} to step \textcircled{4}, the process described above with reference to FIG. 2 may be applied in the same manner. In other words, when a program fail occurs in a process in which first data DT1 is programmed, the first data DT1 stored in the page buffer 371 may be transmitted to the temporary buffer 372, and the temporary buffer 372 may store the first data DT1.

At step \textcircled{5}, the controller 200 may transmit a program command for second data DT2 to the nonvolatile memory device 300. The program command may include the second data DT2 and an information on an address corresponding to a second page P2 in which the second data DT2 is to be stored.

At step \textcircled{6}, the program control circuit 390 may control a program operation for the second data DT2 based on the program command of the controller 200. In detail, the program control circuit 390 may control the second data DT2 received from the controller 200, to be stored in the page buffer 371, and may control the second data DT2 stored in the page buffer 371, to be programmed to the second page P2. Since the first data DT1 in which the program fail occurred is stored in the temporary buffer 372, even though the program operation for the second data DT2 is performed, the loss of the first data DT1 does not occur in the nonvolatile memory device 300.

FIG. 4 is a diagram describing a process in which a read operation for another data is performed after data is stored in the temporary buffer 372 in accordance with an embodiment. For convenience of explanation and illustrative purposes, a first memory block DB1 including five pages P1 to P5 is illustrated in FIG. 4, as an example. Hereunder, the embodiment will be described with reference to FIGS. 1, 2, and 4.

For step \textcircled{1} to step \textcircled{4}, the process described above with reference to FIG. 2 may be applied in the same manner. In other words, when a program fail occurs in a process in which first data DT1 is programmed, the first data DT1 stored in the page buffer 371 may be transmitted to the temporary buffer 372, and the temporary buffer 372 may store the first data DT1.

At step \textcircled{5}, the controller 200 may transmit a read command for third data DT3 to the nonvolatile memory device 300. The read command may include an information on an address corresponding to a third page P3 in which the third data DT3 is stored. It is assumed that the third data DT3 is stored in the third page P3 which is included in the first memory block DB1.

At step \textcircled{6}, the program control circuit 390 may control a read operation for the third data DT3 based on the read command of the controller 200. In detail, the program control circuit 390 may control the third data DT3 to be read from the third page P3 and be stored in the page buffer 371, and may control the third data DT3 stored in the page buffer 371, to be transmitted to the controller 200. Since the first data DT1 in which the program fail occurred is stored in the temporary buffer 372, even though the read operation for the third data DT3 is performed, the loss of the first data DT1 does not occur in the nonvolatile memory device 300.

While not shown, the program control circuit 390 may perform the read operation for the third data DT3, by controlling the third data DT3 stored in the page buffer 371, to be transmitted to the controller 200.

As described above, when the first data DT1 is stored in the temporary buffer 372 according to the present embodiment, it is not necessary to transmit the first data DT1 stored in the page buffer 371, to the controller 200. Furthermore, even though operations according to other commands (for example, the program command for the second data DT2 in FIG. 3 and the read command for the third data DT3 in FIG. 4), including operations performed by the page buffer 371, are performed, the first data DT1 in which the program fail occurred may be prevented from being lost since it is stored in the temporary buffer 372.

FIG. 5 is a diagram describing a process in which data is reprogrammed, in accordance with an embodiment. For convenience of explanation and illustrative purposes, a first memory block DB1 including five pages P1 to P5 is illustrated in FIG. 5, as an example. Hereunder, the embodiment will be described with reference to FIGS. 1, 2 and 5.

For step \textcircled{1} to step \textcircled{4}, the process described above with reference to FIG. 2 may be applied in the same manner. In other words, it is assumed that, when a program fail occurs in a process in which first data DT1 is programmed, the first data DT1 stored in the page buffer 371 is transmitted to the temporary buffer 372 and the temporary buffer 372 stores the first data DT1.

At step \textcircled{5}, the controller 200 may transmit a reprogram command for the first data DT1 to the nonvolatile memory device 300. The reprogram command may include an information on an address corresponding to a fourth page P4 in which the first data DT1 is to be stored. Namely, the reprogram command may not include the first data DT1 as a reprogram target and may include only an information on an address corresponding to a page to be reprogrammed. According to an embodiment, the controller 200 may transmit, together with the reprogram command for the first data DT1, a command instructing the temporary buffer 372 to output the first data DT1, to the nonvolatile memory device 300. While it is illustrated that a reprogram operation for the first data DT1 in which the program fail occurred is performed in the fourth page P4, that is, a page other than the first page P1 in which the program fail occurred, it is to be noted that the embodiment is not limited thereto and the reprogram operation may be performed again in the first page P1.

When only an information on an address corresponding to a page to be reprogrammed is included in a reprogram command according to the present embodiment, since it is not necessary to transmit data to be reprogrammed, a time for performing a reprogram operation may be shortened, and as a result, the performance of the memory system 100 may be improved.

At step \textcircled{6}, the program control circuit 390 may control the first data DT1 stored in the temporary buffer 372 to be programmed to the fourth page P4, based on the reprogram command of the controller 200. That is, the first data DT1 which is stored in the nonvolatile memory device 300 by the program command for the first data DT1 outputted from the controller 200 is not erased and is stored in the temporary buffer 372. Thus, the first data DT1 may be programmed to the fourth page P4 without the need of receiving again the first data DT1 from the controller 200.

While it was explained that the fourth page P4 in which the first data DT1 is reprogrammed is positioned in the same memory block as the first page P1 in which the program fail occurred, it is to be noted that the present invention is not limited thereto. That is, the first page P1 and the fourth page P4 may be positioned in different memory blocks, respectively. According to an embodiment, a memory block in which a program fail has occurred (for example, the first memory block DB1 shown in FIG. 5) may be determined as a bad block. In this case, program to the first memory block DB1 may be prohibited.

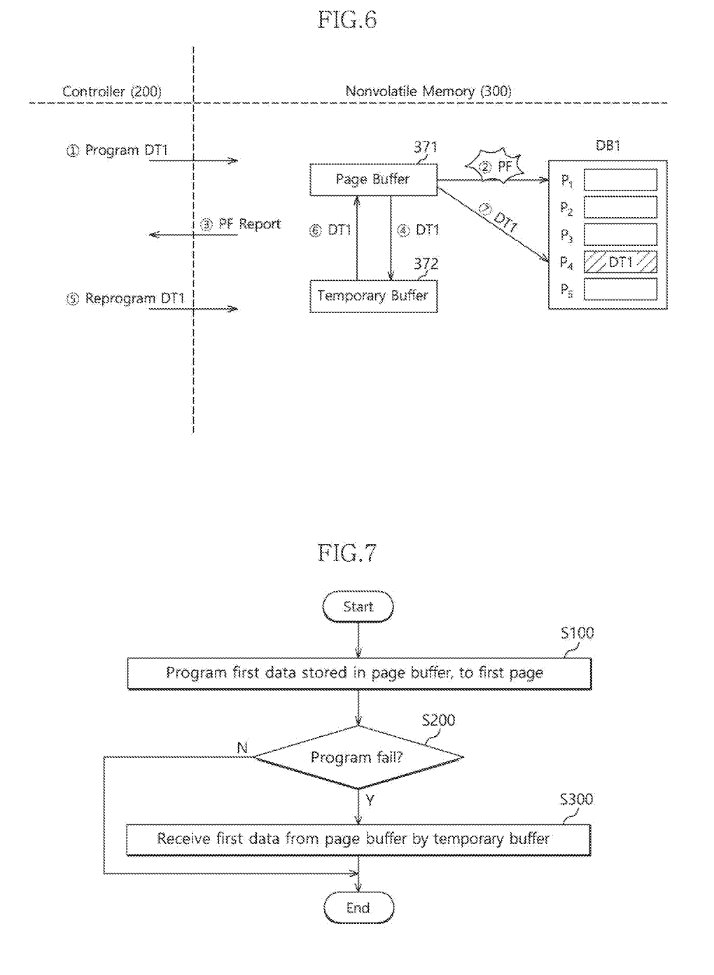

FIG. 6 is a diagram describing a process in which data is reprogrammed, in accordance with an embodiment. For convenience of explanation and illustrative purposes, a first memory block DB1 including five pages P1 to P5 is illustrated in FIG. 6, as an example. Hereunder, the embodiment will be described with reference to FIGS. 1, 2 and 6.

For step \textcircled{1} to step \textcircled{4}, the process described above with reference to FIG. 2 may be applied in the same manner. In other words, when a program fail occurs in a process in which first data DT1 is programmed, the first data DT1 stored in the page buffer 371 may be transmitted to the temporary buffer 372, and the temporary buffer 372 may store the first data DT1.

At step \textcircled{5}, the controller 200 may transmit a reprogram command for the first data DT1 to the nonvolatile memory device 300. The reprogram command may include a command to transmit the first data DT1 to the page buffer 371 and an information on an address corresponding to a fourth page P4 in which the first data DT1 is to be stored. In other words, the reprogram command may not include the first data DT1 as a reprogram target. While it is illustrated that a reprogram operation for the first data DT1 in which the program fail occurred is performed in the fourth page P4, that is, a page other than the first page P1 in which the program fail occurred, it is to be noted that the embodiment is not limited thereto and the reprogram operation may be performed again in the first page P1.

Based on the reprogram command of the controller 200, at step \textcircled{6}, the program control circuit 390 may control the first data DT1 stored in the temporary buffer 372 to be transmitted to the page buffer 371 and at step \textcircled{7}, the program control circuit 390 may control the first data DT1 stored in the page buffer 371 to be programmed to the fourth page P4. That is, the first data DT1 which is stored in the nonvolatile memory device 300 by the program command for the first data DT1 outputted from the controller 200 is not erased and is stored in the temporary buffer 372. Thus, the first data DT1 may be transmitted from the temporary buffer 372 to the page buffer 371. Then, in the same manner as the previous program method, the first data DT1 stored in the page buffer 371 may be controlled to be programmed to the fourth page P4. Therefore, the first data DT1 may be programmed to the fourth page P4 without the need of receiving again the first data DT1 from the controller 200.

While it was explained that the fourth page P4 in which the first data DT1 is reprogrammed is positioned in the same memory block as the first page P1 in which the program fail occurred, it is to be noted that the present invention is not limited thereto. That is, the first page P1 and the fourth page P4 may be positioned in different memory blocks, respectively. Also, a memory block in which a program fail has occurred (for example, the first memory block DB1 shown in FIG. 6) may be determined as a bad block, and program to the first memory block DB1 may be prohibited.

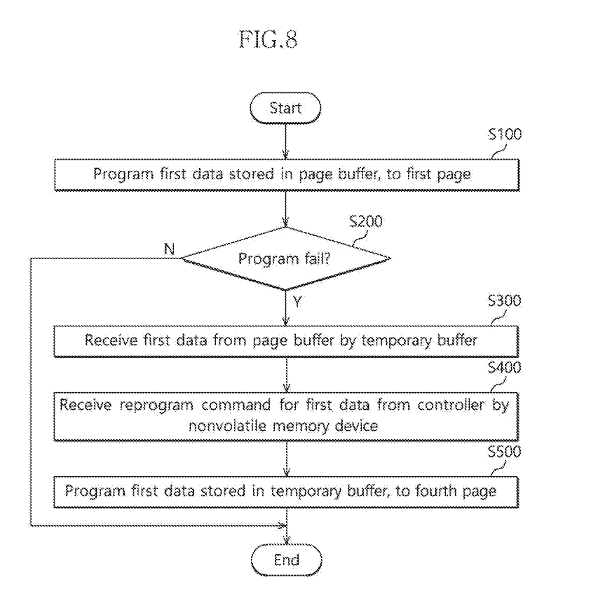

FIG. 7 is a flow chart describing a method for operating a memory system in accordance with an embodiment.

Referring to FIG. 7, the method for operating a memory system in accordance with the embodiment may include programming first data stored in a page buffer to a first page, at step S100; determining whether a program fail has occurred, at step S200; and receiving and storing the first data from the page buffer by a temporary buffer when it is determined at step S200 that a program fail has occurred, at step S300.

Also, the method for operating a memory system in accordance with the embodiment may further include receiving a program command for second data from a controller by a nonvolatile memory device (not shown); storing the second data in the page buffer by the nonvolatile memory device based on the program command (not shown); and programming the second data stored in the page buffer, to a second page by the nonvolatile memory device (not shown).

Moreover, the method for operating a memory system in accordance with the embodiment may further include receiving a read command for third data stored in the nonvolatile memory device, from the controller by the nonvolatile memory device (not shown); and performing a read operation for the third data, by the nonvolatile memory device (not shown).

FIG. 8 is a flow chart describing a method for operating a memory system in accordance with an embodiment.

Referring to FIG. 8, the method for operating a memory system in accordance with the embodiment may further include receiving a reprogram command for the first data from the controller by the nonvolatile memory device (S400) and reprogramming the first data stored in the temporary buffer to a fourth page, by the nonvolatile memory device based on the reprogram command, at step S500.

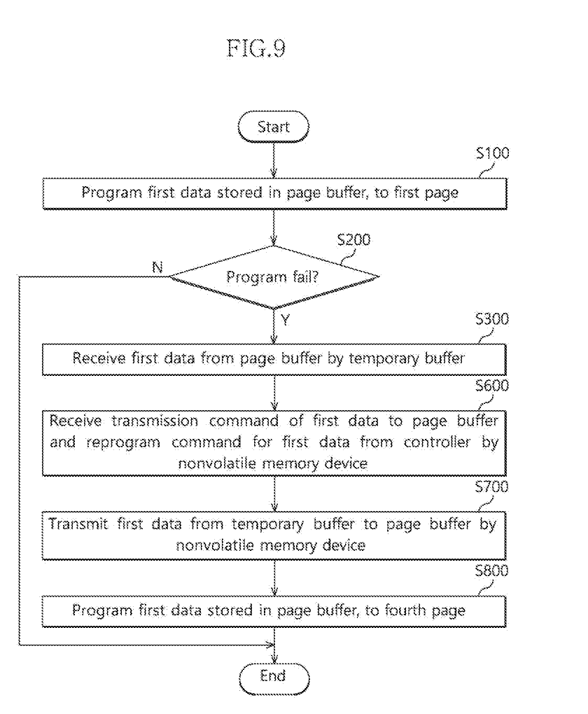

FIG. 9 is a flow chart describing a method for operating a memory system in accordance with an embodiment.

Referring to FIG. 9, the method for operating a memory system in accordance with the embodiment may further include receiving a transmission command of the first data to the page buffer and a reprogram command for the first data, from the controller by the nonvolatile memory device (S600), transmitting the first data from the temporary buffer to the page buffer by the nonvolatile memory device based on the transmission command (S700) and reprogramming the first data stored in the page buffer, to a fourth page by the nonvolatile memory device based on the reprogram command, at step S800.

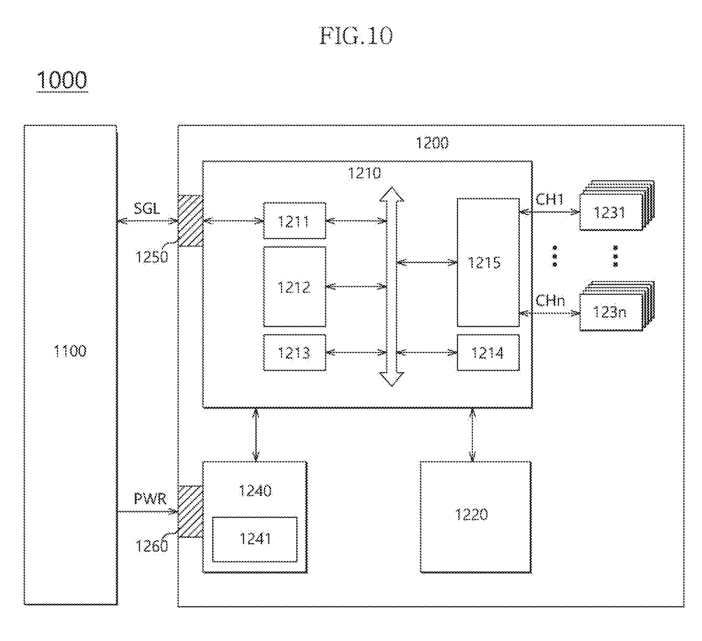

FIG. 10 is a diagram illustrating an example of a data processing system including a solid state drive (SSD) in accordance with an embodiment. Referring to FIG. 10, a data processing system 1000 may include a host device 1100 and an SSD 1200.

The SSD 1200 may include a controller 1210, a buffer memory device 1220, nonvolatile memory devices 1231 to 123n, a power supply 1240, a signal connector 1250, and a power connector 1260.

The controller 1210 may control general operations of the SSD 1200. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnection (PCI), PCI express (PCI-E) and universal flash storage (UFS).

The control unit 1212 may analyze and process a signal SGL inputted from the host device 1100. The control unit 1212 may control operations of internal function blocks according to a firmware or a software for driving the SSD 1200. The random access memory 1213 may be used as a working memory for driving such a firmware or software.

The error correction code (ECC) unit 1214 may generate the parity data of data to be transmitted to the nonvolatile memory devices 1231 to 123n. The generated parity data may be stored together with the data in the nonvolatile memory devices 1231 to 123n. The error correction code (ECC) unit 1214 may detect an error of the data read out from the nonvolatile memory devices 1231 to 123n, based on the parity data. If a detected error is within a correctable range, the error correction code (ECC) unit 1214 may correct the detected error.

The memory interface unit 1215 may provide control signals such as commands and addresses to the nonvolatile memory devices 1231 to 123n, according to control of the control unit 1212. Moreover, the memory interface unit 1215 may exchange data with the nonvolatile memory devices 1231 to 123n, according to control of the control unit 1212. For example, the memory interface unit 1215 may provide the data stored in the buffer memory device 1220, to the nonvolatile memory devices 1231 to 123n, or provide the data read out from the nonvolatile memory devices 1231 to 123n, to the buffer memory device 1220.

The buffer memory device 1220 may temporarily store data to be stored in the nonvolatile memory devices 1231 to 123n. Further, the buffer memory device 1220 may temporarily store the data read out from the nonvolatile memory devices 1231 to 123n. The data temporarily stored in the buffer memory device 1220 may be transmitted to the host device 1100 or the nonvolatile memory devices 1231 to 123n according to control of the controller 1210.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

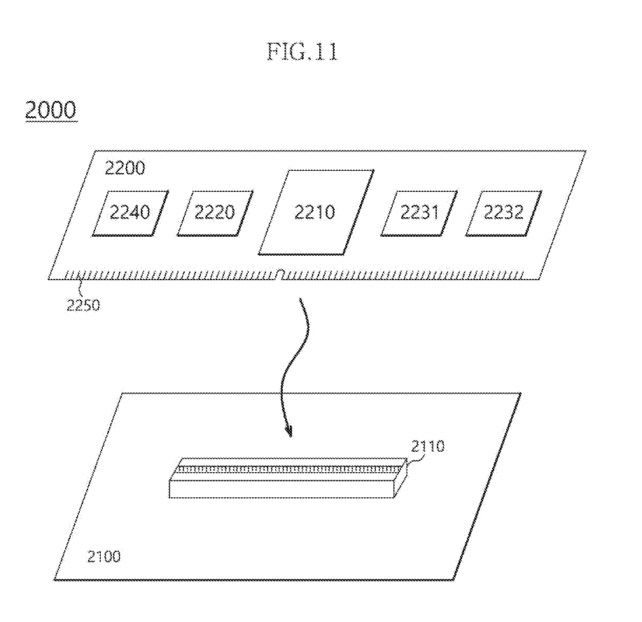

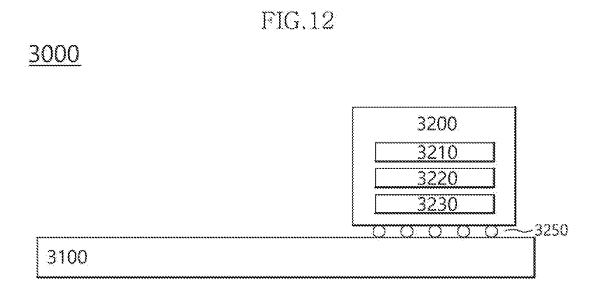

FIG. 11 is a diagram illustrating an example of a data processing system including a memory system in accordance with an embodiment. Referring to FIG. 11, a data processing system 2000 may include a host device 2100 and a memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control the general operations of the memory system 2200. The controller 2210 may be configured in the same manner as the controller 1210 shown in FIG. 10.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as the storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be constructed into various types depending on an interface scheme between the host device 2100 and the memory system 2200. The connection terminal 2250 may be disposed on any one side of the memory system 2200.

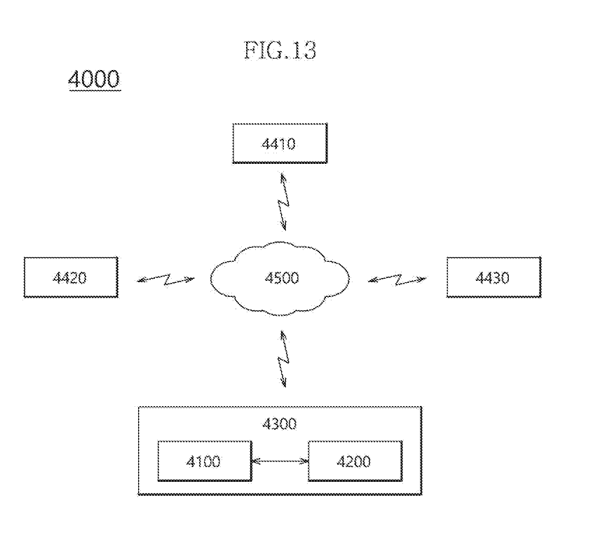

FIG. 12 is a diagram illustrating an example of a data processing system including a memory system in accordance with an embodiment. Referring to FIG. 12, a data processing system 3000 may include a host device 3100 and a memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control the general operations of the memory system 3200. The controller 3210 may be configured in the same manner as the controller 1210 shown in FIG. 10.

The buffer memory device 3220 may temporarily store data to be stored in the nonvolatile memory device 3230. Further, the buffer memory device 3220 may temporarily store the data read out from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

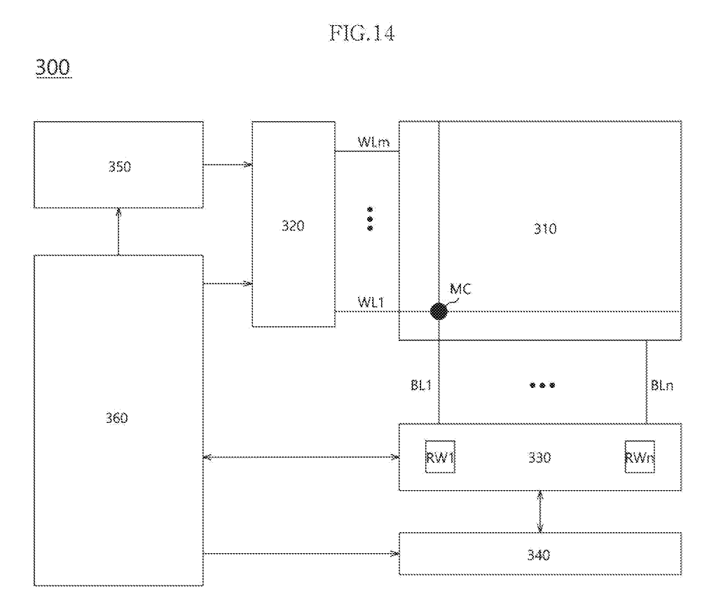

FIG. 13 is a diagram illustrating an example of a network system including a memory system in accordance with an embodiment. Referring to FIG. 13, a network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 of FIG. 1, the SSD 1200 of FIG. 10, the memory system 2200 of FIG. 11 or the memory system 3200 of FIG. 12.

FIG. 14 is a block diagram illustrating an example of a nonvolatile memory device included in a memory system in accordance with an embodiment. Referring to FIG. 14, a nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to the control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to the control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to the control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines (or data input/output buffers), based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For still another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control the read, write and erase operations of the nonvolatile memory device 300.

The descriptions for the above-described device and system may be applied to the methods in accordance with the embodiments of the present disclosure. Therefore, descriptions the same as the descriptions for the above-described device and system are omitted in the methods.

While various embodiments have been described above, it will be understood to those skilled in the art that the embodiments described are examples only. Accordingly, the memory system, the operating method thereof and the nonvolatile memory device described herein should not be limited based on the described embodiments.

What is claimed is:

1. A nonvolatile memory device comprising:
a page buffer configured to store first data and program the first data to a first page, based on a program command for the first data transmitted from a controller;
a temporary buffer configured to receive and store the first data from the page buffer;
a controller interface configured to interface with the controller; and
a program control circuit configured to control operations of the page buffer and the temporary buffer,
wherein the program control circuit controls the temporary buffer to receive and store the first data from the page buffer when a program fail has occurred.

2. The nonvolatile memory device according to claim 1, wherein, when the controller interface receives an operation command for data other than the first data from the controller after the first data is stored in the temporary buffer, the program control circuit performs an operation for the data other than the first data and controls the first data stored in the temporary buffer to be retained.

3. The nonvolatile memory device according to claim 1, wherein, when the controller interface receives a program command for second data from the controller after the first data is stored in the temporary buffer, the program control circuit controls the second data to be stored in the page buffer and controls the second data stored in the page buffer to be programmed to a second page.

4. The nonvolatile memory device according to claim 1, wherein, when the controller interface receives a read command for third data from the controller after the first data is stored in the temporary buffer, the program control circuit controls a read operation for the third data to be performed.

5. A memory system comprising:
a controller; and
a nonvolatile memory device configured to include a page buffer, a temporary buffer which receives and stores first data from the page buffer when a program fail has occurred in a process of programming the first data stored in the page buffer, a controller interface which interfaces with the controller, and a program control circuit which controls operations of the page buffer and the temporary buffer,
wherein the controller transmits a reprogram command for the first data to the nonvolatile memory device, and
wherein the program control circuit controls the first data stored in the temporary buffer to be reprogrammed to a fourth page, based on the reprogram command.

6. The memory system according to claim 5, wherein, when the controller interface receives an operation command for data other than the first data from the controller after the first data is stored in the temporary buffer, the program control circuit performs an operation for the data other than the first data and controls the first data stored in the temporary buffer to be retained.

7. The memory system according to claim 5, wherein the reprogram command includes an address corresponding to the fourth page in which the first data is to be reprogrammed.

8. The memory system according to claim 5,
wherein the controller transmits a transmission command of the first data to the page buffer and the reprogram command, to the nonvolatile memory device, and
wherein the program control circuit controls the first data stored in the temporary buffer to be transmitted to the page buffer, based on the transmission command, and controls the first data stored in the page buffer to be reprogrammed to the fourth page, based on the reprogram command.

9. The memory system according to claim 5, wherein, when a program command for second data is received from the controller after the first data is stored in the temporary buffer, the program control circuit controls the second data to be stored in the page buffer and controls the second data stored in the page buffer to be programmed to a second page.

10. The memory system according to claim 5, wherein, when the controller interface receives a read command for third data from the controller after the first data is stored in the temporary buffer, the program control circuit controls a read operation for the third data to be performed.

11. A method for operating a memory system, comprising:
programming first data stored in a page buffer, to a first page by a nonvolatile memory device; and
receiving and storing the first data from the page buffer by a temporary buffer when a program fail has occurred.

12. The method according to claim 11, further comprising:
receiving a program command for second data from a controller by the nonvolatile memory device;
storing the second data in the page buffer by the nonvolatile memory device based on the program command; and
programming the second data stored in the page buffer, to a second page by the nonvolatile memory device.

13. The method according to claim 11, further comprising:
receiving a read command for third data stored in the nonvolatile memory device, from the controller by the nonvolatile memory device; and
performing a read operation for the third data by the nonvolatile memory device.

14. The method according to claim 11, further comprising:
receiving a reprogram command for the first data from the controller by the nonvolatile memory device; and
reprogramming the first data stored in the temporary buffer, to a fourth page by the nonvolatile memory device based on the reprogram command.

15. The method according to claim 14, wherein the reprogram command includes an address corresponding to the fourth page in which the first data is to be reprogrammed.

16. The method according to claim 11, further comprising:
receiving a transmission command of the first data to the page buffer and a reprogram command for the first data, from the controller by the nonvolatile memory device;
transmitting the first data from the temporary buffer to the page buffer by the nonvolatile memory device based on the transmission command; and
reprogramming the first data stored in the page buffer, to a fourth page by the nonvolatile memory device based on the reprogram command.

17. The method according to claim 16, wherein the reprogram command includes an address corresponding to the fourth page in which the first data is to be reprogrammed.
